(19) United States
(12) Patent Application Publication
(10) Pub. No.: US 2024/0408525 A1
(43) Pub. Date: Dec. 12, 2024

(54) FILTER MODULE WITH INDEPENDENTLY REMOVABLE FILTERS

(71) Applicant: PAT TECHNOLOGY SYSTEMS INC., Vaudreuil-Dorion (CA)

(72) Inventors: Chau Thien VO, Roxboro (CA); Anthony KAZAZIAN, Pincourt (CA)

(21) Appl. No.: 18/735,656

(22) Filed: Jun. 6, 2024

Related U.S. Application Data
(60) Provisional application No. 63/506,679, filed on Jun. 7, 2023.

(51) Int. Cl. B01D 46/00; B01D 46/62

(52) U.S. Cl. CPC B01D 46/0005; B01D 46/62; B01D 2265/02

(57) ABSTRACT

A filter module for a fume extraction system or air purifier may have a first frame member, the first frame member being annular and defining a first opening and a second frame member. A first conduit member may defines an air inlet configured to be connected to an air source. A second conduit member defines an air outlet configured to outlet air. The filter module may have a first filter and a second filter, and a mechanism. At least the first annular frame, the first conduit member and the second conduit member define a passage including the first opening for insertion and removal of the first filter and the second filter to reach an aligned position in which at least the first filter and the second filter are in series relative to an airflow direction and form an air conduit with the first conduit member and the second conduit member. The mechanism releasably maintains at least the first filter and the second filter between the first conduit member and the second conduit member.

### CROSS-REFERENCE TO RELATED APPLICATION

The present application claims the priority of U.S. Patent Application No. 63/506,679, filed on Jun. 7, 2023, the contents of which are incorporated herein by reference.

### BACKGROUND OF THE ART

Some air purifiers and/or fume extractors are designed in such a way that the air filters are located within a rigid sheet-metal or plastic cabinet that may also house the blower and control system. As such, the size of the filter(s) and/or total size of a filter stack (multiple filters stacked in series) is dependent on the size of the cabinet, so as to maintain the intended sealed pathway between the blower and air filter or filter stack. In order to have an air purifier or fume extractor product line to address the multitude of filter size requirements, a vast inventory of cabinets may be required.

In order to avoid the necessity of maintaining such an inventory of cabinets, it would be desirable to consider a modular design for air purifiers and/or fume extractors. A modular design of an air purifier may have a blower and control in a dedicated enclosure or cabinet separate from the filters. The air filter(s) would be physically mated to an inlet and outlet plenum by a filter module. The blower/control module would be in fluid communication with the filter module by way of a removable, flexible or rigid duct. Some additional benefit may nevertheless be obtained by adding modularity to a filter module.

### SUMMARY

In one aspect, there is provided a filter module for a fume extraction system or air purifier comprising: a first frame member, the first frame member being annular and defining a first opening; a second frame member; a first conduit member defining an air inlet configured to be connected to an air source; a second conduit member defining an air outlet configured to outlet air; at least a first filter and a second filter; and a mechanism; wherein at least the first annular frame, the first conduit member and the second conduit member define a passage including the first opening for insertion and removal of the first filter and the second filter to reach an aligned position in which at least the first filter and the second filter are in series relative to an airflow direction and form an air conduit with the first conduit member and the second conduit member; wherein the mechanism releasably maintains at least the first filter and the second filter between the first conduit member and the second conduit member.

In another aspect, there is provided a method for installing a filter in a filter module, comprising: sliding a filter along a first direction until the filter reaches an aligned position relative to a first conduit member and a second conduit member; causing a relative displacement of the first conduit member relative to the second conduit member for the filter to be held captive, the relative displacement being in a second direction, the second direction being transverse to the first direction; and inducing a gas flow through the filter module.

### DESCRIPTION OF THE DRAWINGS

Reference is now made to the accompanying figures in which:

FIG. 1 is a first perspective of a filter module with independently removable filters in accordance with a variant of the present disclosure, in an operational state;

FIG. 2 is a second perspective view of the filter module of FIG. 1, in the operational state;

FIG. 3 is a perspective view of the filter module of FIG. 1, with a filter being installed;

FIG. 4 is an elevation view of a toggle clamp of the filter module of FIG. 1;

FIG. 5 shows elevation views of the toggle clamp of FIG. 4, in a clamped and a retracted condition; and

FIG. 6 is a view of the filter module of FIG. 1, showing an angular freedom thereof during installation of filters.

### DETAILED DESCRIPTION

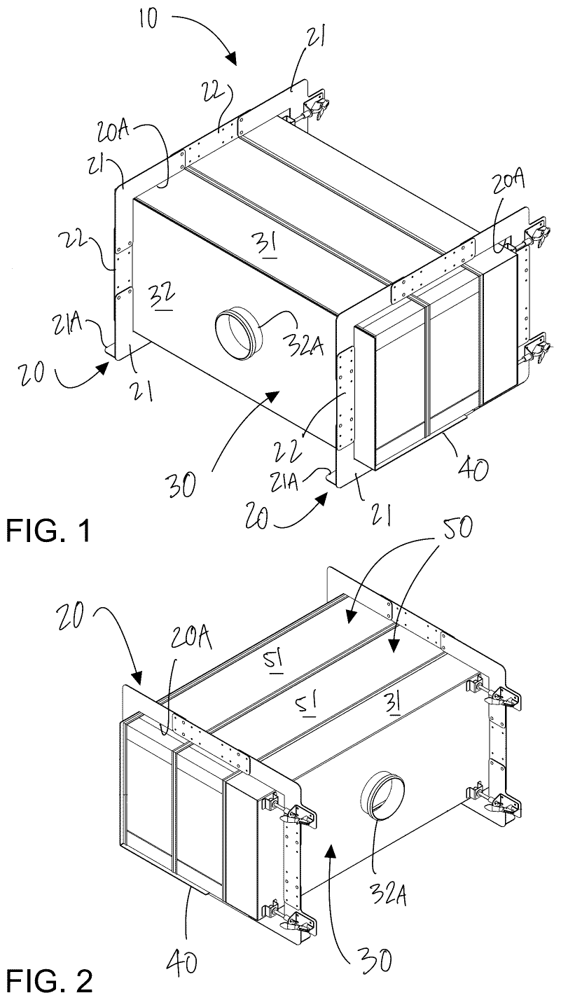

Referring to FIGS. 1-2, a filter module 10 for a fume extraction system, air purifier, air filtration apparatus, or any other air treatment apparatus, in accordance with a particular embodiment is shown. The filter module 10 may be referred to as a filter module with independently removable filters. The filter module 10 is of the type that may be part of a whole system, but tasked with filtering the air, while another module may provide motive air flow, such as a blower/control module. Stated differently, though the filter module 10 could include a fan, blower, controller, such as in one of the conduit members described below, the filter module 10 could be said to be passive by the absence of any powered component therein. The filter module 10 may also be connected to other components, such as a hood, or any other air capture element.

The filter module 10 may be regarded as an assembly, an apparatus, a system, a device, a unit, etc. For simplicity, reference is made herein to module 10. The filter module 10 may have various components, such as frame members 20, conduit members 30 defining an air inlet configured to be connected to an air source or air outlet configured to outlet air, a frame plate 40, one or more filters 50, and/or one or more mechanisms 60 to hold the various components together. Other components may be present in the filter module 10, including sensors, fasteners, electronic components, etc.

In FIGS. 1 and 2, the frame members 20 are similar to one another and will be concurrently referred to as 20. The filter module 10 is shown employing two frame members 20, but a single one could be used, or the frame members 20 being shown as separate components in the figures could be interconnected and be part of a single frame. In the illustrated variant, each frame member 20 is an annular frame having a central opening 20A. The annular frames 20 may have a rectangular outer shape and central opening 20A, as shown. The frame members 20 may be of fixed dimension. However, in the illustrated embodiment, each frame member 20 may be split along its length and/or its height, by having four corner bracket 21, and four attachment plates 22. Some of the corner brackets 21 may have a flange 21A, to fix the filter module 10 to a structure, to a wall, to the ground, to the ceiling, etc. Flanges 21A may be optional, as other attachment configurations are considered. If the frame member 20 is only expandable in length or height, it may only have two attachment plates 22.

Each frame member 20 may be bound together as a continuous donut with the attachment plates 22 that are bolted to the corner brackets 21. The corner brackets 21 and/or the attachment plates 22 may have multiple bolt hole positions to further expand the range of adjustability. Alternatively, the frame members 20 may have expansion joints, such as with lockable corner brackets 21 and attachment plates 22. If the frame member 20 needs to be made longer to accommodate larger filter components or more filters than what the bolt hole positions permit, one can replace the attachment plates 22 along the length with longer attachment plates 22. Similarly, if the frame member 20 needs to be taller, one can replace the attachment plates 22 along the height with longer ones.

Still referring to FIGS. 1 and 2, the filter module 10 may have conduit members 30. In the illustrated embodiment, the conduit members 30 may have a casing portion 31, and a coupling plate 32, concurrently defining a plenum. The casing portion 31 would be sealingly applied against one of the filters 50. An air inlet or air outlet 32A may project from a plane of the coupling plate 32. For example, as shown, the inlet and/or outlet 32A may be spigots, as a possibility among others. The coupling plate 32 would be sealingly applied against one of the filters 50 if there is no casing portion 31.

As an alternative embodiment, the conduit members 30 are simply embodied by the coupling plate 32, with or without a spigot. The inlet and outlet 32A may simply be holes. One of the conduit members 30 may define the plenum, while another may be just a coupling plate 32. If one of the conduit members 30 defines the plenum, it may include a blower as a possibility.

In a variant, frame plate 40 may be present. The frame plate 40 may have a main body 41 that is substantially planar. A stopper end 42 may project from an edge of the main body 41. In a variant, the stopper end 42 may be a bent portion of the same sheet metal as that defining the main body 41. The frame members 30 may be held together in parallel by the frame plate 40, though this could be done by the conduit members 30 as well or instead.

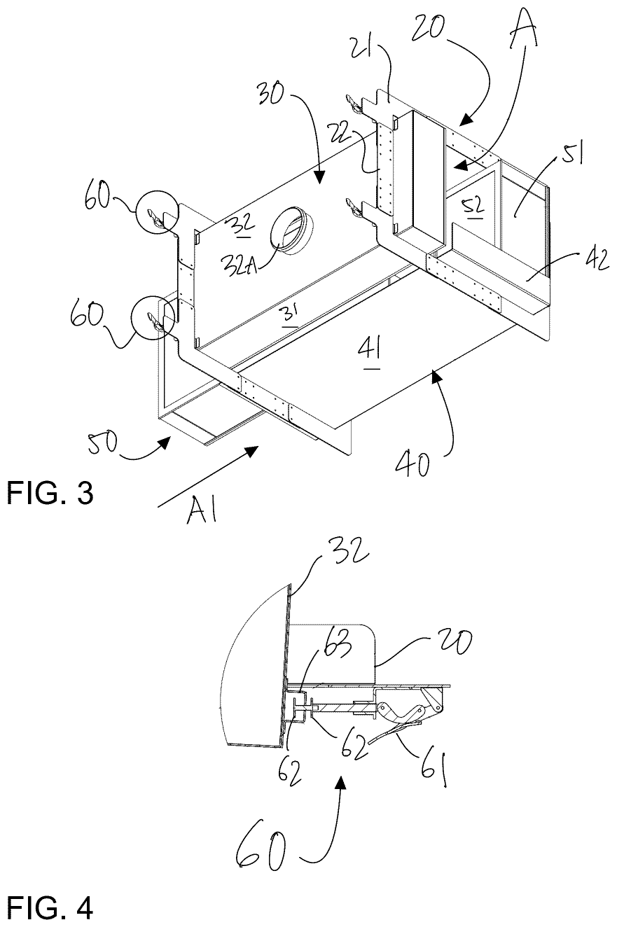

Still referring to FIGS. 1, 2 and 3, the filters 50 may each have a casing portion 51, shown as being rectangular in shape, though other shapes are possible. Though not visible, the casing portion 51 defines a frame around a filter member 52 (e.g., a filter panel). The filter member may be of any type depending on the use of the filter module 10. The filter member is configured to allow air or a gas to pass through it, and capture some airborne particles, fumes, etc. Hence, the expression filter is used to cover any device through which air flows that retains a fluid, gas or solid as the air flows through it. This includes fume extraction and capture of volatile organic compounds (VOCs), as they are filtered out of the air flow.

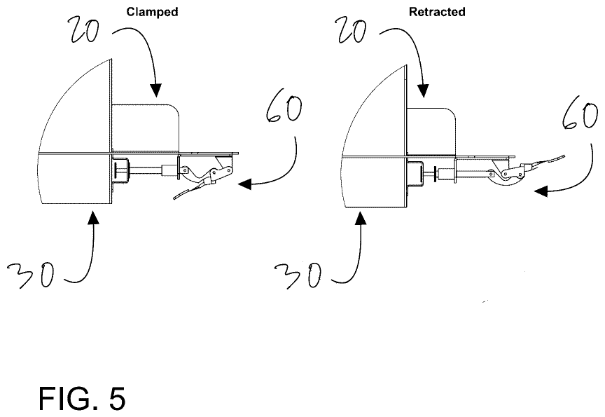

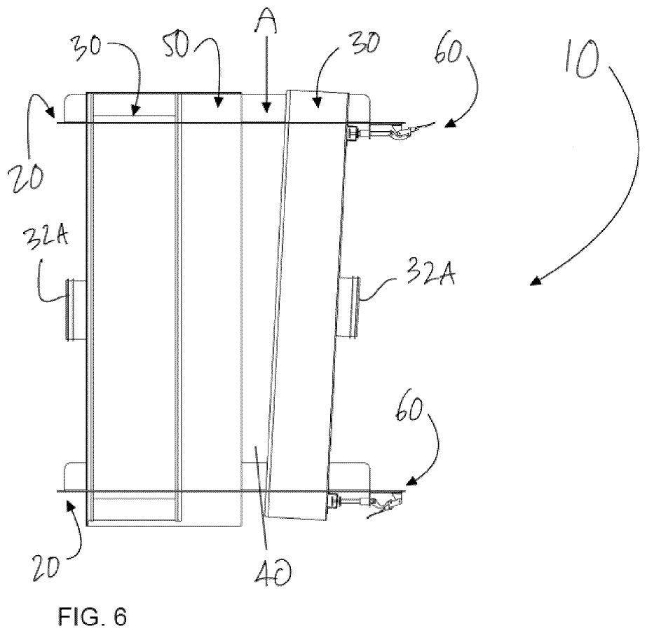

Referring to FIGS. 4, 5 and 6, mechanism(s) 60 may be present, to assist in maintaining the filter(s) 50 between the conduit members 30, in a manner described below. In the illustrated embodiment, there are a pair of the mechanisms 60, embodied as a toggle clamp, connected at one end to one of the frame members 20, and at another end to one of the conduit members 30. Accordingly, by displacing a lever 61, a length of the toggle clamp 60 varies. In a variant, the mechanism 60 is held captive by the frame member 20, and by the conduit member 30. It may also be possible to adjust a length of a rod portion of the toggle clamp 60. Thus, the mechanism(s) 60 may allow a relative movement between the conduit members 30, to increase or reduce a length between them. The clamping ends of the toggle clamps 60 are held captive by the conduit member or plate 30. The manner in which the clamps 60 are held captive allow the conduit member 30 to have some freedom of angular movement to allow the toggle clamps 60 to be activated non simultaneously. The end of the toggle clamps 60 may have two flanges 62 or like abutments that interfere with a smaller hole in a captivating bracket 63 fastened to the outside surface of the conduit member 30. The flanges 62 are placed on either side of a hole in the captivating bracket 63. The hole is smaller than the flanges 62 but larger than the shaft of the toggle clamp 60. This allow each toggle clamp 60 to have some angular play but yet still have the ability to push and to pull the conduit member 30. In a variant, the mechanism 60 is a clamp or a vise, such as a pair of jaws threadingly engaged on a threaded rod and displaceable along the threaded rod. The mechanism 60 in such a configuration could be supported by the frame members 20 or not, and could apply pressure against both conduit members 30.

As alternatives to the toggle clamp, the mechanism 60 may be an elastic(s), a biased piston or rod, fasteners including clamping bolts, quick-release levers, to apply a pressure on the conduit members 30 and filter(s) 50, and keep the assembly sandwiched together.

Now that the various components of the filter module 10 have been described, an assembly thereof is set forth, with reference to FIGS. 2-6.

The conduit members 30 may define a passage A including the opening 20A of one or both of the frame members 20, for insertion and removal of the filter(s) 50 to reach an aligned position in which the filter(s) 50 is between the inlet and outlet 32A, between the conduit members 30. One of the frame members 20 may act as a stopper and not be part of the passage A. If there are more than one filter 50, the filters 50 are in series relative to an airflow direction and form an air conduit with the conduit members 30. Accordingly, the filters 50 may be slid into aligned position, along direction A1. Direction A1 may be transverse to the airflow direction.

The frame plate 40 may act as a base for the filter(s) 50 to slide onto and a backstop when in the horizontal orientation. When in the vertical position, the frame plate 40 may serve as a back stop and a vertical alignment. The frame plate 40 may thus contribute to ensuring that the filter(s) 50 are in the aligned position.

The mechanism(s) 60 releasably secures the filter(s) 50 between the conduit members 30. As observed, the gap between the conduit members 30 is varied, such that the layered assembly of the conduit members 30 and filter(s) 50 may be sandwiched. Therefore, in the illustrated variant, the conduit member 30 is fastened to the frame member 20, but has the capacity to move along the axis of the airflow direction. This allows the conduit member 30 to be clamped down against the filter(s) 50 and compress gaskets between the filter(s) 50 and the conduit members 30. The movement of the conduit member 30 or plate may be limited by the throw of the toggle clamps 60.

The pushing action of the mechanism 60 clamps the filter(s) 50 together between the conduit members 30, compressing the gasket seals or equivalent component together ensuring an air-tight seal. In a variant, the filters 50 have a frame portion surrounding a filter portion, with the frame portions of adjacent filters 50 configured to form a sealed engagement when against one another, whether gaskets, seals or the like are present or not. The filter portion is the portion through which air flows. The pulling action helps to separate the conduit members 30 from the filter gaskets (if present) that may become sticky over time. Being captive, the conduit member 30 connected to the mechanism(s) 60 may be prevented from falling over, when the filter module 10 is in the horizontal orientation with the filter(s) 50 being removed. In addition, the captive conduit member 30 is suspended while the filter module 50 is in the vertical orientation and the filter(s) 50 are removed. Not having to completely remove and handle the conduit members 30 makes the replacement of filter(s) 50 easier and less cumbersome.

The filter module 10 can be placed either horizontal or vertical orientation, where the airflow is flowing horizontally through the filter or vertically, respectively. The novel filter module allows the user to easily configure and reconfigure the frame members 20 to accommodate various sizes of filters and filter stacks.

The filter module 10 may generally be described as having a first frame member, the first frame member being annular and defining a first opening; a second frame member; a first conduit member defining an air inlet configured to be connected to an air source; a second conduit member defining an air outlet configured to outlet air; at least a first filter and a second filter; a mechanism. The first annular frame, the first conduit member and the second conduit member define a passage including the first opening for insertion and removal of the first filter and the second filter to reach an aligned position in which at least the first filter and the second filter are in series relative to an airflow direction and form an air conduit with the first conduit member and the second conduit member. The mechanism releasably maintains the at least the first filter and the second filter between the first conduit member and the second conduit member.

A method of using the filter module may including sliding one or more filters between conduit members until an aligned position is reached; pressing one of the conduit members against the one or more filters to sandwich the filter(s) between the conduit members to form air tight seals; and use the filter module in a serial flow from one of the conduit members, through the filter(s) to filter the gas passing through the filter(s) and out via the other of the conduit members. The method may include installing a filter while another filter is already present. The method may also include removing a filter while another filter remains in the aligned position. The method may also include installing and/or removing a filter while the filter module remains connected to a conduit. The method may including adjusting a size of frame members before installing the filters and conduit members.

A method for installing a filter in a filter module may include sliding a filter along a first direction until the filter reaches an aligned position relative to a first conduit member and a second conduit member; causing a relative displacement of the first conduit member relative to the second conduit member for the filter to be held captive, the relative displacement being in a second direction, the second direction being transverse to the first direction; and inducing a gas flow through the filter module. Inducing a gas flow may be done for example by activating a blower in a blower module or in the filter module. The relative displacement may be caused or induced by manipulating toggle clamps.

The method may further include sliding another filter along the first direction until the other filter reaches an aligned position relative to the first conduit member and the second conduit member. Causing the relative displacement of the first conduit member relative to the second conduit member causes the filter and the other filter to be held captive. The method may be performed while the first conduit member and/or the second conduit member are connected to a conduit. Sliding the filter along the first direction includes sliding the filter in a vertical direction or in a horizontal direction.

The filter module 10 may be said to be casing-less, or without a casing, in that the conduit portions 30 and the filter(s) 50 define the gas flow passage. It can also be said that, if one views the gas flow passage as being bounded by a casing, it is the conduit portions 30 and the filter(s) 50 that define the casing. The casing may be said to change dimensions based on the number of filters 50.

The above description is meant to be exemplary only, and one skilled in the art will recognize that changes may be made to the embodiments described without departing from the scope of the invention disclosed. For example, there may be applications where only a series of particulate filters are used (without a gas filter), though the filters will be of different efficiencies or different media to address different type of particulates that may exist in the particulate contaminant mixture which may be free of gaseous contaminants. There also may be applications where only a series of gas filters are used (no particulate filters), though the filters will be of different efficiencies or different media to address different type of gases that may exist in the gaseous contaminant mixture which may be free of particulate contaminant. Modifications which fall within the scope of the present invention will be apparent to those skilled in the art, in light of a review of this disclosure, and such modifications are intended to fall within the appended claims.

1. A filter module for a fume extraction system or air purifier comprising:
a first frame member, the first frame member being annular and defining a first opening;
a second frame member;
a first conduit member defining an air inlet configured to be connected to an air source;
a second conduit member defining an air outlet configured to outlet air;
at least a first filter and a second filter; and
a mechanism;
wherein at least the first annular frame, the first conduit member and the second conduit member define a passage including the first opening for insertion and removal of the first filter and the second filter to reach an aligned position in which at least the first filter and the second filter are in series relative to an airflow direction and form an air conduit with the first conduit member and the second conduit member;
wherein the mechanism releasably maintains at least the first filter and the second filter between the first conduit member and the second conduit member.

2. The filter module according to claim 1, wherein the second frame member is annular and defines a second opening.

3. The filter module according to claim 2, wherein the passage includes the second opening.

4. The filter module according to claim 1, wherein the first conduit member includes a first plenum portion.

5. The filter module according to claim 1, wherein the second conduit member includes a second plenum portion.

6. The filter module according to claim 1, wherein the air inlet is a spigot.

7. The filter module according to claim 1, wherein the air outlet is a spigot.

8. The filter module according to claim 1, wherein the first frame member is expandable to expand a size of the first opening.

9. The filter module according to claim 2, wherein the second frame member is expandable to expand a size of the second opening.

10. The filter module according to claim 1, further include a frame plate supported by the first frame member and the second frame member.

11. The filter module according to claim 10, wherein the passage includes the frame plate.

12. The filter module according to claim 11, wherein the frame plate includes a stopper to delimit the aligned position.

13. The filter module according to claim 12, wherein the stopper is a bent portion of the frame plate.

14. The filter module according to claim 1, wherein the mechanism includes at least one toggle clamp between the first frame member and/or the second frame member and the first conduit member and/or the second conduit member.

15. The filter module according to claim 1, wherein the filter module is passive.

16. A method for installing a filter in a filter module, comprising:
sliding a filter along a first direction until the filter reaches an aligned position relative to a first conduit member and a second conduit member;
causing a relative displacement of the first conduit member relative to the second conduit member for the filter to be held captive, the relative displacement being in a second direction, the second direction being transverse to the first direction; and
inducing a gas flow through the filter module.

17. The method according to claim 16, further including sliding another filter along the first direction until the other filter reaches an aligned position relative to the first conduit member and the second conduit member, and wherein causing the relative displacement of the first conduit member relative to the second conduit member causes the filter and the other filter to be held captive.

18. The method according to claim 16, wherein the method is performed while the first conduit member and/or the second conduit member are connected to a conduit.

19. The method according to claim 16, wherein sliding the filter along the first direction includes sliding the filter in a vertical direction.

20. The method according to claim 16, wherein sliding the filter along the first direction includes sliding the filter in a horizontal direction.
